(19) United States
(12) Patent Application Publication
(10) Pub. No.: US 2019/0086580 A1
(43) Pub. Date: Mar. 21, 2019

(54) Optical Coating and Method for Producing an Optical Coating with Reduced Light Scattering

(71) Applicant: Fraunhofer-Gesellschaft zur Förderug der angewandten Forschung e.V., München (DE)

(72) Inventors: Alexander von Finck, Jena (DE); Sven Schröder, Jena (DE); Steffen Wilbrandt, Jena (DE); Olaf Stenzel, Bucha (DE); Angela Duparre, Jena (DE); Gunther Notni, Jena (DE)

(21) Appl. No.: 16/079,376

(22) PCT Filed: Feb. 24, 2017
(86) PCT No.: PCT/EP2017/054373

§ 371 Date: Aug. 23, 2018

(30) Foreign Application Priority Data
Feb. 25, 2016 (DE) 10 2016 103 339.1

(51) Int. Cl. G02B 1/10; G02B 5/08; G02B 27/00

(52) U.S. Cl. CPC G02B 1/10; G02B 27/0018; G02B 5/0858

(57) ABSTRACT

An optical coating and a method for producing an optical coating with reduced light scattering are disclosed. In an embodiment, an optical coating includes at least one scattering zone, wherein the scattering zone is arranged on a surface of the optical coating, wherein an electric field strength of the electromagnetic radiation has a minimum in the scattering zone in order to reduce scattering of the electromagnetic radiation, and wherein the electric field strength has the minimum above the surface of an uppermost layer of the optical coating.

This patent application is a national phase filing under section 371 of PCT/EP2017/054373, filed Feb. 24, 2017, which claims the priority of German patent application 10 2016 103 339.1, filed Feb. 25, 2016, each of which is incorporated herein by reference in its entirety.

### TECHNICAL FIELD

The invention relates to an optical coating having a reduced light scattering and a process for producing such an optical coating.

### BACKGROUND

The function of optical components that are provided with a reflection-increasing or reflection-reducing coating, for example, can be impaired by scattered light, which can occur particularly at surface contaminations. For example, scattering losses reduce transmission or reflection. Light scattering produces interference light, which can reduce contrast in imaging optical systems, for example.

Contaminations on the surface of optical components that can cause unwanted light scattering are often unavoidable and usually increase continuously during the use of the optical component. Cleaning the optical component to reduce contamination is often difficult or even impossible, for example, with optical elements for use in space.

The source of light scattering can not only be contamination, but also defects in the layer structure or functional nanostructures, for example.

### SUMMARY OF THE INVENTION

Embodiments provide an optical coating having a reduced light scattering. Furthermore, embodiments provide a process for the production of the optical coating.

According to at least one embodiment, the optical coating is configured to reflect or transmit electromagnetic radiation of a given wavelength or wavelength range. The given wavelength or the given wavelength range can, for example, be in the visible range of the optical spectrum or cover the visible range. Alternatively, it is also possible that the given wavelength or the given wavelength range is wholly or partly within the UV or IR range.

The optical coating can be in particular a reflection-increasing or a reflection-reducing coating. As a reflection-increasing coating, the optical coating can be applied to a reflector, for example. In the case of an anti-reflective coating, for example, the optical coating can be applied to a transparent optical element that is intended to be characterized by high transmission.

The optical coating has at least one scattering zone. The scattering zone is an area of optical coating in which scattering can occur. The scattering zone is arranged on the surface of the optical coating. In an embodiment, the scattering zone can be a surface area of the optical coating in which contamination can occur that can lead to the scattering of electromagnetic radiation. Alternatively, the scattering zone may be an area of the optical coating that may have contaminations and/or defects and/or nanostructures suitable for scattering the electromagnetic radiation. In other words, the scattering zone is an area in which light scattering by contamination particles, defects or specifically produced nanostructures can occur. The term “scattering zone” refers here and in the following to an area of the coating in which scattering could occur due to its properties or contaminations such as particles, in particular dust particles, or fluids. However, this does not mean that scattering is intended in this area; rather, the scattering in the scattering zone should be specifically reduced in the optical coating described here.

In the optical coating, the electric field strength of the electromagnetic radiation in the scattering zone has advantageously a minimum in order to reduce the scattering of the electromagnetic radiation in the scattering zone. The electric field strength of the radiation reflected and/or transmitted during the intended use of the optical coating is advantageous in the area of the scattering zone lower than in other areas of the optical coating. In this way it is advantageously achieved that only a comparatively low light scattering occurs at the contaminations, defects and/or nanostructures in the scattering zone.

The optical coating described here takes advantage of the principle of reducing unwanted light scattering not only by avoiding or reducing contamination or defects, but also by setting up the properties of the optical coating in such a way that the optical coating is particularly insensitive to the formation of light scattering. Because the electric field strength in the area of the scattering zone is particularly low, comparatively little scattered light is produced even if the scattering zone shows contaminations, defects and/or nanostructures.

According to at least one embodiment, the optical coating has at least one layer with a thickness adjusted in such a way that the electric field strength in the area of the scattering zone has a minimum. It turned out that the electric field strength at a given position of the optical coating, especially in the area of the scattering zone, can be specifically influenced by varying the layer thickness of at least one layer.

By means of a simulation calculation in which the thickness of at least one or more layers of the optical coating is varied, the thickness of the at least one or more layers can thus be adjusted in such a way that the field strength in the scattering zone has a minimum. Simulation programs for the design of optical layer systems can be used to carry out the simulation calculation. Such simulation programs are known to the expert per se and are used in particular to vary the layer thicknesses for a given layer system in such a way that the best possible adaptation of the transmission or reflection to a target is achieved within a given wavelength and/or angle range. Alternatively or additionally, one or more other optical properties of the optical coating can be optimized, such as color, phase, group delay, group delay dispersion and/or absorption.

The layer which thickness varies during the simulation calculation and is adjusted in such a way that the field strength in the scattering zone is at a minimum, can be in particular the uppermost layer of the optical coating. For example, the optical coating can have a metallic mirror layer with a dielectric protective layer arranged thereon, the thickness of the dielectric protective layer being adjusted such that the field strength in a scattering zone in the region of the surface of the dielectric protective layer becomes minimal. Alternatively, it is also possible to vary the thickness of at least one layer arranged inside the optical coating. In particular, the thickness of several layers can be varied simultaneously.

In a preferred embodiment of the optical coating, the scattering zone is located at the surface of the optical coating. In particular, the scattering zone can be an area at the surface of the optical coating that contains contamination particles or defects, for example, scratches in the surface. In this embodiment, the minimum electric field strength is advantageously located on the surface or above the surface of the uppermost layer of the optical coating.

In the case of defects such as scratches located directly on the surface of the top layer or partially extending into the surface of the uppermost layer, the electric field strength preferably has a minimum at the surface of the uppermost layer or in accordance with the depth of the scratches just below the surface of the uppermost layer.

If the scattering centers are mainly formed by contamination particles located on the surface of the uppermost layer, the electric field strength has a minimum above the surface of the uppermost layer. In this case, the position of the minimum electric field strength is preferably adapted to the mean diameter of the contamination particles. For example, if the expected contamination particles have an average diameter of about 40 nm, the minimum electric field strength can be positioned 20 nm above the surface of the top layer. The minimum electric field strength in this case, seen vertically, is thus approximately in the middle of the area on the surface that contains contamination particles. The position of the minimum of the electric field strength above the surface is therefore preferably about half the mean diameter of the contamination particles. Preferably, the minimum electric field strength is in a range between 10 nm and 2.5 μm above the surface of the uppermost layer.

However, the scattering zone does not necessarily have to be located at the surface of the optical coating. Rather, the scattering zone can comprise any area of the optical coating in which an increased scattering of radiation is to be expected due to defects or nanostructures. The optical coating may in particular comprise a substrate, and the scattering zone may comprise an interface between the substrate and the optical coating. For example, the immediate vicinity of the substrate surface can have an increased defect density, which can lead to light scattering. Such an increased defect density in the area of the substrate surface can be caused, for example, by a roughness of the substrate or a defect-rich growth zone of the layer applied first.

In a further embodiment, the optical coating has a nanostructure, and the scattering zone comprises the nanostructure. In optical coatings, nanostructures are often produced specifically on the surface in order to achieve a reflection-reducing effect. Furthermore, nanostructures can also be provided as diffractive optical elements. In order to reduce the light scattering in such a nanostructure, the minimum of the electric field strength of the optical coating is preferably arranged in the area of the nanostructure.

Furthermore, a method for producing an optical coating with reduced light scattering is specified. According to at least one embodiment, the method comprises determining a layer design of the optical coating, wherein the determination of the layer design comprises determining the arrangement of the layers, determining the layer materials and determining the layer thicknesses. Preliminary initial values can first be defined for the layer thicknesses, which are then optimized calculatively.

In the method, a calculative optimization of the reflection or transmission of the optical coating for a given wavelength or a given wavelength range by variation of at least one layer parameter is carried out advantageously. The at least one layer parameter can be at least one layer thickness. The given wavelength or the given wavelength range depends on the intended application of the optical coating. In calculative optimization, the thickness of at least one layer or preferably several layers, in particular of all layers of the optical coating, is preferably varied in order to adapt a transmission or reflection calculated for the optical coating as well as possible to a target. Such an optimization and suitable simulation programs are known to the skilled person per se and are therefore not explained in detail.

Furthermore, the position of a scattering zone of the optical coating is determined advantageously, whereby the scattering zone has contaminations, defects and/or nanostructures which are suitable for the scattering of electromagnetic radiation. To determine the position of the scattering zone, for example, it is estimated in which range light scattering is to be expected when the optical coating is used as intended. In particular, this can be an area at the surface of the optical coating where contamination by dust, particles and/or fluids is to be expected during operation.

In the method, the position of a minimum of the electric field strength is also advantageously optimized by variation of at least one layer parameter in such a way that the electric field strength in the scattering zone has a minimum. For this purpose, a simulation calculation is preferably carried out in which the course of the electric field strength in the optical coating is simulated at the given wavelength or the given wavelength range. The mathematical optimization of the position of a minimum of the electric field strength can, for example, take place simultaneously with the optimization of the reflection or transmission or in a subsequent calculation step.

The layer parameter, which is varied to optimize the position of the minimum of the electric field strength, is preferably the thickness of at least one layer of the optical coating. In particular, the layer thicknesses can first be optimized in such a way that the requirements for reflection and/or transmission are fulfilled as well as possible, and subsequently the thickness of at least one layer is optimized in such a way that the minimum of the electric field strength lies in the scattering zone.

The at least one layer, of which the thickness is varied, can be in particular the uppermost layer of the optical coating. In particular, the at least one layer can be an oxide layer or fluoride layer, for example, a metal oxide layer.

In a preferred embodiment of the method, the calculative optimization of the reflection or transmission and the calculative optimization of the position of the minimum of the electric field strength are repeated at least once. By varying the thickness of a layer so that the electric field strength in the scattering zone is at a minimum, the preferably previously optimized reflection or transmission properties may possibly be impaired. In this case, after optimization of the at least one layer thickness, one or more layer thicknesses may be optimized again with respect to the reflection or transmission properties and, if necessary, a further optimization with respect to the position of the minimum of the electric field strength. These steps can be repeated several times if necessary. In this way, iteratively optimal layer thicknesses can be found for which the requirements for reflection properties or transmission properties and for the position of the minimum of the electric field strength in the scattering zone are fulfilled as well as possible.

It is also possible to perform the calculative optimization of the reflection or transmission and the calculative optimization of the position of the minimum of the electric field strength simultaneously. For example, the reflection or transmission can be optimized by varying one or more layer thicknesses under the boundary condition that the electric field strength in the scattering zone has a minimum. Both in the iterative optimization of the layer parameters and in the simultaneous optimization of the layer parameters, in particular the layer thicknesses, a compromise between the best possible reflection and transmission properties and the position of the minimum of the electric field strength is advantageously found.

In an embodiment of the method, the determination of the position of the scattering zone includes an estimation of the critical or typically expected particle diameters of expected contaminations on the surface of the optical coating. The position of the scattering zone is preferably determined in such a way that the scattering zone lies in the area of the particle diameters above the surface. The scattering zone thus begins in a vertical direction at the surface and ends at a distance from the surface which corresponds to the particle diameters or, in the case of particles of different sizes, the mean particle diameter. If, for example, contaminations with particle sizes of 20 nm to 40 nm are expected on the surface of the coating, the range between 0 nm and 40 nm above the surface is determined as the scattering zone, for example.

After the calculative optimization of the layer parameters, especially the layer thicknesses, the optical coating is produced with the optimized layer parameters. The optical coating can, for example, be applied to a substrate using coating processes known per se, whereby the substrate in particular can be an optical component and the optical coating can be a reflection-increasing or reflection-reducing coating.

Further advantageous configurations of the method can be derived from the previous description of the optical coating and vice versa.

The optical coating is particularly intended for use in optical systems that are highly sensitive to stray light due to contamination or defects. The optical coating can be applied to optical components such as mirrors, lenses, optical windows (e.g., to protect sensitive sensors, to separate filling gases or as exit windows for lasers), beam splitters or polarizing optics.

Furthermore, the optical coating is particularly suitable for optical systems that are exposed to high laser powers. The optical coating is characterized in particular by a low sensitivity to laser-induced destruction, especially with laser pulses in the nanosecond range, since this is also strongly correlated with the local field strength.

### BRIEF DESCRIPTION OF THE DRAWINGS

The invention is explained in more detail below based on exemplary embodiments in connection with FIGS. 1 to 5.

In the Figures:

FIG. 1 shows a schematic representation of a cross-section through an optical coating according to an embodiment and the course of the electric field strength E;

FIG. 2 shows the scattering losses as a function of the layer thickness of the uppermost layer for an example of the optical coating;

FIG. 3 shows a schematic representation of examples of optical coatings with different layer thicknesses of the uppermost layer;

FIG. 4 shows a schematic graphic representation of the scattered light output as a function of the scattering angle for the examples with different layer thicknesses of the uppermost layer shown in FIG. 3; and

FIG. 5 shows a schematic diagram of the reflectivity and scattering loss as a function of the degree of contamination of the surface for an optical layer system according to an embodiment and a comparison example.

Same or similar acting components are provided with the same reference signs in the figures. The components shown and the proportions between the components are not to be regarded as true to scale.

### DETAILED DESCRIPTION OF ILLUSTRATIVE EMBODIMENTS

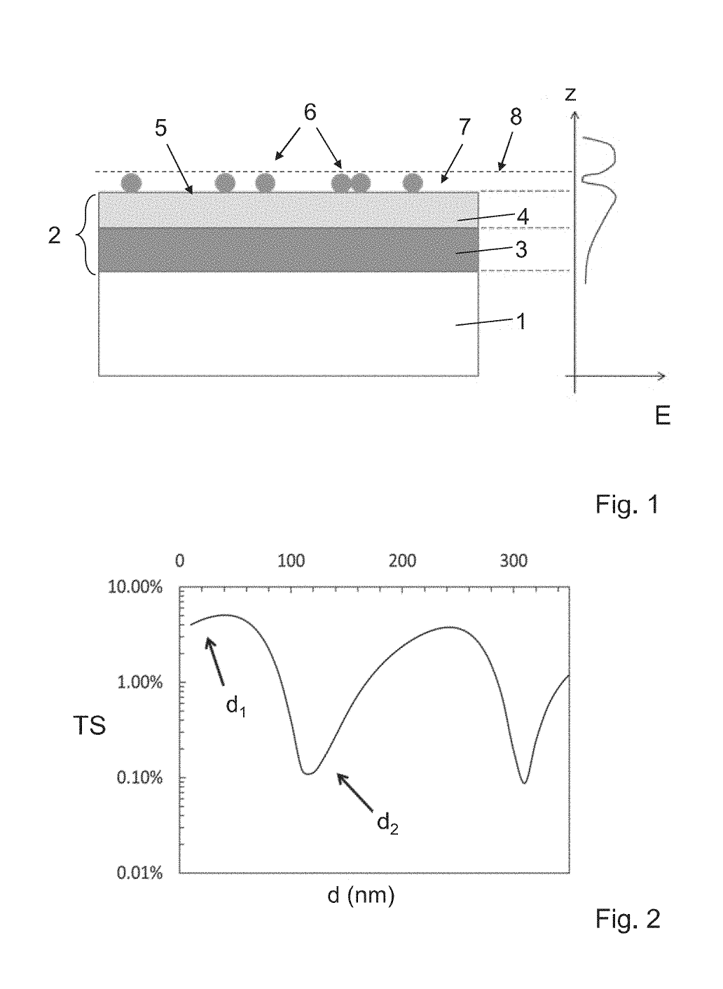

The embodiment of an optical coating 2 shown in FIG. 1 comprises a layer sequence applied to a substrate 1, which comprises a metal layer 3 and a dielectric layer 4 arranged thereon. In the embodiment, the optical coating 2 is a reflection-increasing coating in which a high reflection is achieved, in particular by the metal layer 3, which may be an aluminum layer, for example. The dielectric layer 4 applied to metal layer 3 is preferably an oxide layer, in particular a metal oxide layer such as an Al₂O₃ layer. The dielectric layer 4 is preferably essentially transparent and serves in particular to protect the metal layer 3 from external influences.

When using the optical coating 2, contamination particles 6 may accumulate on the surface 5 of the optical coating 2, which could lead to an undesired scattering of light. This is particularly the case when surface 5 is difficult or impossible to clean when using the optical coating 2, or when the optical coating is used under conditions where surface 5 can be easily soiled.

Since the contamination particles 6 form possible scattering centers for light, the area above surface 5, which has a vertical extent corresponding to the particle diameter of the contamination particles 6, represents a scattering zone 7. In a vertical direction z, which runs perpendicular to the layer planes of the optical coating, the area between surface 5 and an upper limit 8, which is given by the particle diameter of the contamination particles, is the scattering zone 7. The upper limit 8 of the scattering zone 7 is symbolized in FIG. 1 by a dashed line.

The course of the electric field strength E in the vertical direction z shown in FIG. 1 shows that the electric field strength E has a minimum in the area of the scattering zone 7. In this way it is advantageously achieved that the contamination particles 6 deposited on surface 5 emit only little scattered light when the optical coating 2 is used as intended, in particular as a reflector.

This can be achieved in the production of the optical coating 2, for example, by adjusting the thickness of dielectric layer 4 in such a way that the electric field strength in the area of the scattering zone 7 is at a minimum. A suitable thickness of dielectric layer 4 is found, for example, by a simulation calculation.

Such a simulation calculation is shown as an example in FIG. 2, in which the total scattering loss TS is shown as a function of the layer thickness d of the uppermost layer of an optical coating. The total scattering loss TS by surface contamination was simulated for an optical coating which has an aluminum layer and an Al₂O₃ layer arranged on it according to the embodiment in FIG. 1.

For the simulation, an illumination wavelength λ=640 nm and contamination particles with particle diameters of 200 nm were assumed. It can be seen that the scattering loss TS is particularly low at certain layer thicknesses of, for example, about 120 nm or 310 nm. With these optimized layer thicknesses of the uppermost Al₂O₃ layer, it is possible to reduce the scattering loss by a factor of about 40 compared to a non-optimized layer system, for example, with a layer thickness of 0 nm or 50 nm.

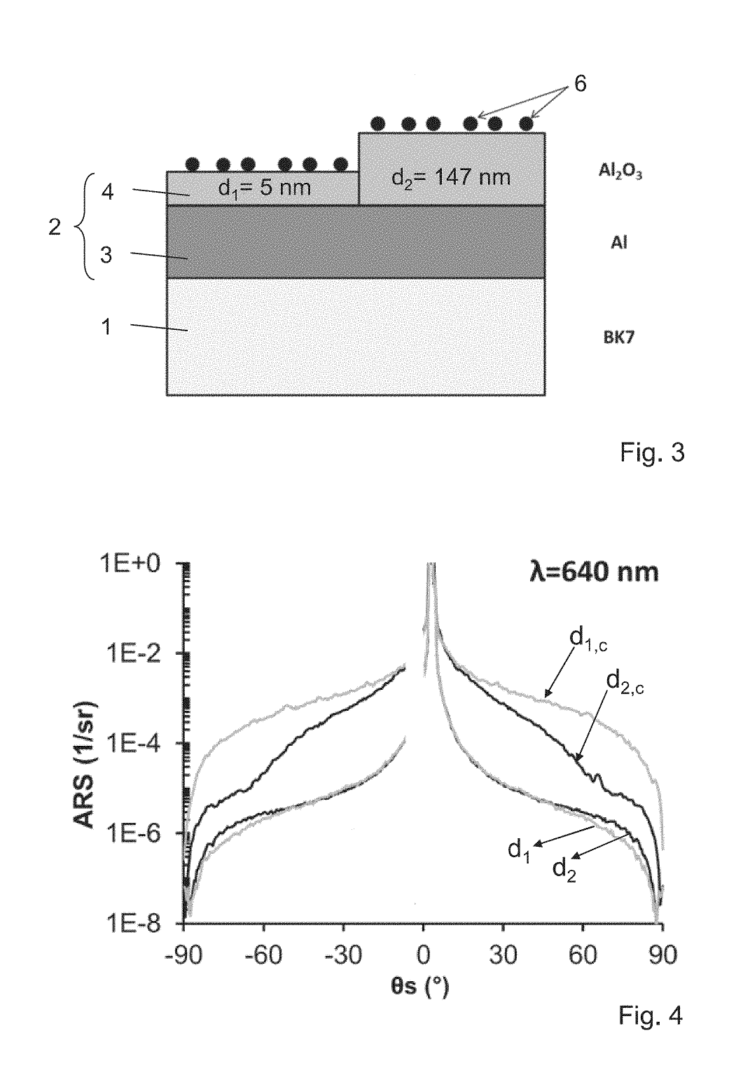

FIG. 3 shows schematically the layer structure of embodiments of the optical coating 2 with a substrate 1 composed of BK7 glass, a 100 nm thick aluminum layer 3 and an Al₂O₃ layer 4. In the example shown on the left, the Al₂O₃ layer has a thickness of d₁=5 nm. In the example on the right, the Al₂O₃ layer has a thickness of d₂=147 nm.

FIG. 4 shows measurements of the angle-resolved scattering (ARS) as a function of the scattering angle θ_{S} for the embodiments with the different layer thicknesses d₁ and d₂ shown in FIG. 3 before contamination (curves d₁ and d₂) and after contamination of the surface with polystyrene spheres with 200 nm diameter (curves d_{1,c} and d_{2,c}).

The Angle Resolved Scattering (ARS) is defined as ARS(θ_{S},ϕ_{S})=ΔP_{S}(θ_{S},ϕ_{S})/(PᵢΔΩ_{S}). ΔP_{S} corresponds to the power scattered into the solid angle element ΔΩ_{S}, where θ_{S} is the polar scatter angle and ϕ_{S} is the azimuthal scatter angle. Pᵢ is the incident power. Alternatively, the BSDF (Bidirectional Scattering Distribution Function) can also be used, which can be calculated via BSDF(θ_{S},ϕ_{S})=ARS(θ_{S},ϕ_{S})/cos(θ_{S}) from the ARS. It can be seen that the angle-resolved scattering and thus the scattering loss in the example with the optimized layer thickness d₂=147 nm is considerably lower than in the example with d₁=5 nm.

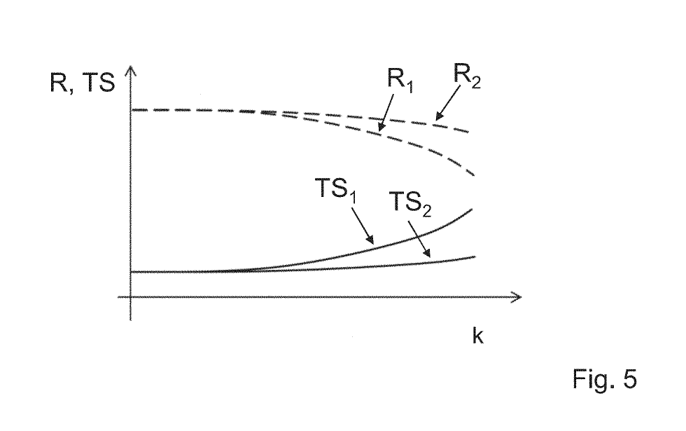

FIG. 5 schematically shows the reflectivity R and the scattering loss TS as a function of the degree of contamination k of the surface (in random units) for an optical coating according to an embodiment and a comparison example of an optical coating which is not in accordance with the invention. TS can be calculated by integrating ARS. In the comparative example, the reflectivity R₁ decreases comparatively strongly with increasing contamination level k and the scatter loss TS₁ increases comparatively strongly. With an optical coating according to the exemplary embodiment, the decrease in reflectivity R₂ is considerably lower with increasing degree of contamination. This is due in particular to the fact that in the exemplary embodiment, the scattering loss TS₂ increases less strongly with increasing degree of contamination k than in the comparison example. The optical coating according to the exemplary embodiment therefore has the advantage that a comparatively high reflectivity is maintained even if contamination particles adhere to the surface.

The invention is not limited by the description based on the exemplary embodiments. Rather, the invention includes each new feature and each combination of features, which includes in particular each combination of features in the patent claims, even if this feature or this combination itself is not explicitly indicated in the patent claims or exemplary embodiments.

1-14. (canceled)

15. An optical coating adapted to reflect or transmit electromagnetic radiation of a predetermined wavelength or a wavelength range, the optical coating comprising:
at least one scattering zone,
wherein the scattering zone is arranged on a surface of the optical coating,
wherein an electric field strength of the electromagnetic radiation has a minimum in the scattering zone in order to reduce scattering of the electromagnetic radiation, and
wherein the electric field strength has the minimum above the surface of an uppermost layer of the optical coating.

16. The optical coating according to claim 15, wherein the optical coating comprises at least one layer having a thickness adjusted such that the electric field strength has the minimum in a region of the scattering zone.

17. The optical coating according to claim 16, wherein the layer is the uppermost layer of the optical coating.

18. The optical coating according to claim 15, wherein the scattering zone comprises contamination particles suitable for the scattering of the electromagnetic radiation, and wherein a vertical extent of the scattering zone corresponds to a particle diameter of the contamination particles.

19. The optical coating according to claim 18, wherein the minimum of the electric field strength is about half a mean diameter of the contamination particles above the surface.

20. The optical coating according to claim 15, wherein the minimum of the electric field strength occurs in a range between 10 nm and 2.5 μm above the surface of the uppermost layer.

21. A method for producing an optical coating with reduced light scattering, the method comprising:
determining a layer design of the optical coating, wherein determining the layer design comprises determining an arrangement of layers, determining layer materials of the layers and determining layer thicknesses of the layers;
calculative optimizing a reflection or transmission of the optical coating for a given wavelength or a wavelength range by varying at least one layer parameter;
determining a position of a scattering zone of the optical coating, wherein the scattering zone is a surface region of the optical coating or has contaminations and/or defects and/or nanostructures which are suitable for scattering electromagnetic radiation;
calculative optimizing a position of a minimum of an electric field strength by variation of at least one layer parameter such that the electric field strength in the scattering zone has the minimum; and
producing the optical coating with the layer parameters determined by the calculative optimizations.

22. The method according to claim 21, wherein the calculative optimization of the position of the minimum of the electric field strength comprises a variation of a layer thickness of at least one layer.

23. The method according to claim 22, wherein the at least one layer is an uppermost layer of the optical coating.

24. The method according to claim 22, wherein the at least one layer is an oxide layer or fluoride layer.

25. The method according to claim 21, wherein calculative optimizing the reflection or transmission and calculative optimizing the position of the minimum of the electric field strength are carried out simultaneously and/or are repeated at least once.

26. The method according to claim 21, wherein the electric field strength above the surface of an uppermost layer of the optical coating has a minimum.

27. The method according to claim 21, wherein determining the position of the scattering zone comprises estimating particle diameters of expected contaminants on the surface of the optical coating, and wherein the position of the scattering zone is determined such that the scattering zone lies in a region of the particle diameters above the surface.

28. The method according to claim 21, where the minimum of the electric field strength occurs in a range between 10 nm and 2.5 μm above the surface of an uppermost layer.

29. An optical coating adapted to reflect or transmit electromagnetic radiation of a predetermined wavelength or a wavelength range, the optical coating comprising:
at least one scattering zone,
wherein the scattering zone is arranged on a surface of the optical coating,
wherein an electric field strength of the electromagnetic radiation has a minimum in the scattering zone in order to reduce the scattering of the electromagnetic radiation,
wherein the electric field strength has a minimum above the surface of an uppermost layer of the optical coating, and
wherein the minimum of the electric field strength is located in a range between 10 nm and 2.5 μm above the surface of the uppermost layer.
